(19) United States
(12) Patent Application Publication
(10) Pub. No.: US 2026/0361674 A1
(43) Pub. Date: Nov. 12, 2026

(54) Adaptive Interaction Engine for Personalized Accessibility Solutions

(71) Applicants: Matthew Kaplowitz, New York, NY (US); Mark Francisco, Millstone Township, NJ (US)

(72) Inventors: Matthew Kaplowitz, New York, NY (US); Mark Francisco, Millstone Township, NJ (US)

(21) Appl. No.: 19/672,455

(22) Filed: May 8, 2026

Related U.S. Application Data
(60) Provisional application No. 63/802,383, filed on May 8, 2025.

(51) Int. Cl. H04L 51/224; G06F 40/58; G09B 21/00

(52) U.S. Cl. CPC H04L 51/224; G09B 21/006; G09B 21/009; G06F 40/58

(57) ABSTRACT

An interaction engine provides urgent information (such as emergency alerts, news, and safety instructions to individuals/users with disabilities, including older people in a simplified, understandable manner.

### CROSS-REFERENCE TO RELATED PATENT APPLICATION

This application claims priority from prior provisional patent application Ser. No. 63/802,383 filed May 8, 2025, the entire disclosure of which is incorporated herein by reference.

### BACKGROUND OF THE INVENTION

### Field of the Invention

The present invention relates to digital accessibility and adaptive user experiences and, more particularly, a cloud-based interaction engine designed to tailor communication and media content to individual comprehension needs of users with disabilities and aging populations.

Over one billion people worldwide, including individuals with disabilities and older adults, face significant barriers to communication access. Industries, such as streaming, telehealth, education, emergency services and travel, lack scalable inclusive solutions that accommodate diverse user needs. A diverse population engages with technology in many different ways to access news, alerts, and communication tools, reflecting a wide range of needs and abilities. People with disabilities and older individuals often rely on assistive technologies like screen readers, voice recognition software, IP-delivered translation and IP Relay Services, and haptic alerts to stay informed and connected. Language differences influence how individuals interpret and respond to digital content, while varied levels of education affect which platforms and formats they find most accessible or trustworthy. Age also plays a significant role, as younger users may seamlessly navigate apps and social media, while older adults might prefer email or television-linked alerts. Together, these factors create a complex ecosystem where technology must adapt to support effective, inclusive communication for everyone. In urgent, emergency, or other time bound interactions, clarity and comprehension are critical, particularly due to the cognitive load of user journeys and responses to events in new, critical and sometimes dangerous scenarios.

Existing accessibility technologies provide isolated solutions, but there is a need for a comprehensive platform designed to dynamically adapt content and user interactions across multiple industries.

### SUMMARY OF THE INVENTION

The interaction engine of the present invention provides an innovative, scalable platform designed to address the urgent need for accessible communication across industries. By leveraging AI, cloud technology and real-time communication tools, the platform creates a unified, adaptable experience for individuals with diverse accessibility needs. In one embodiment, the present invention provides a cloud-based, centralized interaction engine that transforms textual, audible and visual media into personalized, accessible experiences. The interaction engine involves technology designed to take data inputs from various sources, such as broadcast television, radio, streaming media, the U.S. Federal Emergency Management Agency's Integrated Public Alert & Warning System (FEMA/IPAWS), websites, audio inputs, authorized personal medical information, and converts the data inputs into a variety of user-directed outputs that cater to personalized needs and preferences.

The interaction engine prepares guided journeys that accommodate language barriers, mobility constraints, and chronic medical conditions. Pre-defined accessibility journeys can be created for specific industries, while others can be rapidly built and deployed based on user needs.

The interaction engine curates and customizes user interactions, enabling seamless integration with real-time communication services such as BeMyEyes, JAWs, Convo, and GoodMaps. By supporting multi-tenancy and reusable workflows, the interaction engine provides a system platform that allows enterprises to implement scalable, cost-effective accessibility solutions without extensive customization. The platform is designed to be adaptable across industries such as emergency management, travel streaming, and education.

The architecture of the interaction engine is, in one embodiment, a cloud-native platform that dynamically curates accessibility-driven guided experiences having a flexible modular framework that enables industry-specific customization and scalability thereby allowing businesses to tailor user interactions based on their unique needs. The platform leverages AI-enhanced processing and integrates live communication tools, ensuring real-time user support and personalized accessibility solutions.

The interaction engine offers pre-built accessibility pathways designed to accommodate diverse industry applications, providing users with structured and intuitive experiences. Adaptive AI models further enhance these interactions by personalizing content and navigation based on individual usability and comprehension needs. The interaction engine presents a platform that is fully compatible across web, mobile, and assistive technologies, ensuring a seamless and consistent experience for all users, regardless of their preferred device.

The platform features a highly scalable infrastructure, making it suitable for deployment across multiple industries. Its robust API ecosystem facilitates secure and efficient enterprise integration, allowing organizations to incorporate accessibility solutions without disrupting existing workflows. The interaction engine is fully compliant with global accessibility regulations, including WCAG, ADA, and regional standards, ensuring that businesses meet legal and ethical accessibility requirements while enhancing inclusivity.

The present invention relates to an interaction engine and associated communication methods and systems. Their sensory and cognitive capabilities define the best method of interaction. An element of the design is the interaction engine, whose primary function is to adapt sensory (visual, audible, haptic) media to the personal and optimal needs of the individual. These adaptations may include, but are not limited to: spoken language translation, text to speech synthesis, speech to text transcription, speech to sign language interpretation, sign language to text or speech translation, haptic pattern generation, audio or text to braille adaptation, audio description of visual elements, educational reading level adaptation.

The interaction engine will adapt these translations to the tools and technology the individual possesses and prefers, for example but not limited to: braille display, feature phone, smartphone, tablet, computer, television, haptic wearable, lighting, telephone. The interaction engine is context aware, which may include knowledge of current: news, weather, individual geolocation, time, local safety incidents. A key aspect of the invention is the secure, private and appropriate understanding of the user's abilities and preferences which may include cognitive abilities.

Other aspects and advantages of the present invention will become apparent from the following description of the invention taken in conjunction with the accompanying drawings.

### BRIEF DESCRIPTION OF THE DRAWINGS

FIG. 1 is a block diagram of an interaction engine according to the present invention used for communication with individuals/users.

FIG. 2 is a block diagram illustrating use of the interaction engine of the present invention interfacing between an alert to be reported and a hand-held personal communication device carried by individuals to be alerted.

FIGS. 3-9 are views of the front of various personal communication devices illustrative of exemplary conditions and alerts being communicated selectively by targeted individuals.

FIG. 10 is a screen view illustrating inputs and outputs provided by an interaction engine according to the present invention displayed on a stationary TV or desktop monitor.

### DETAILED DESCRIPTION OF THE INVENTION

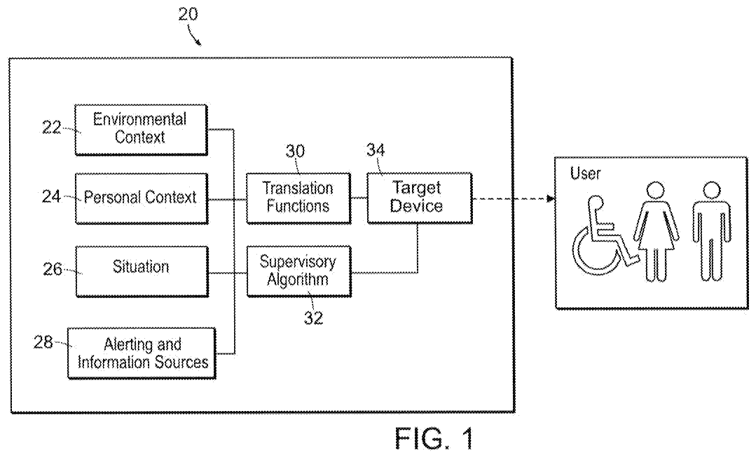

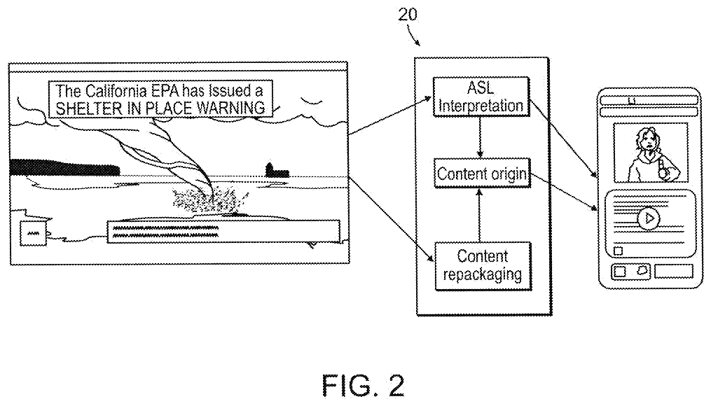

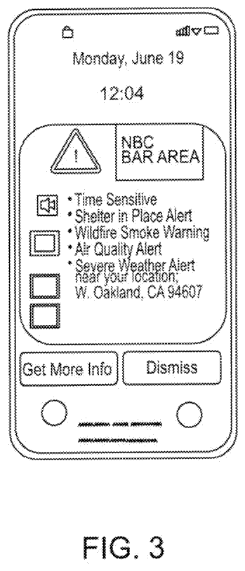

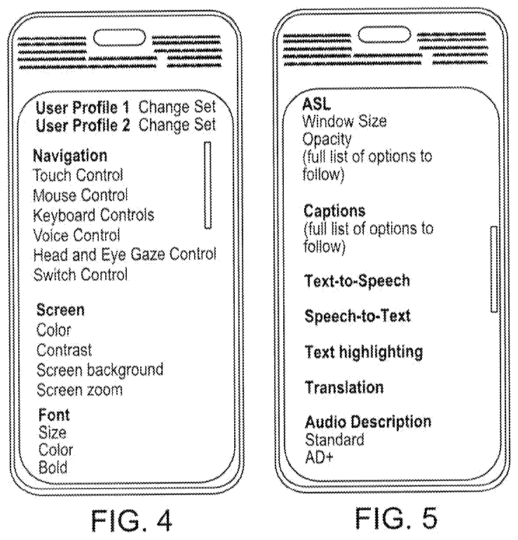

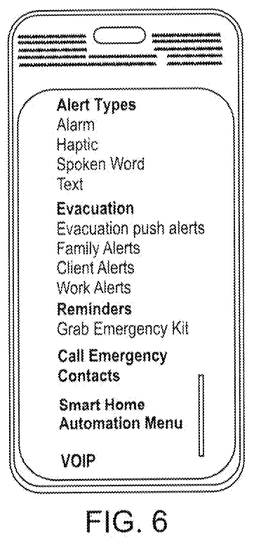

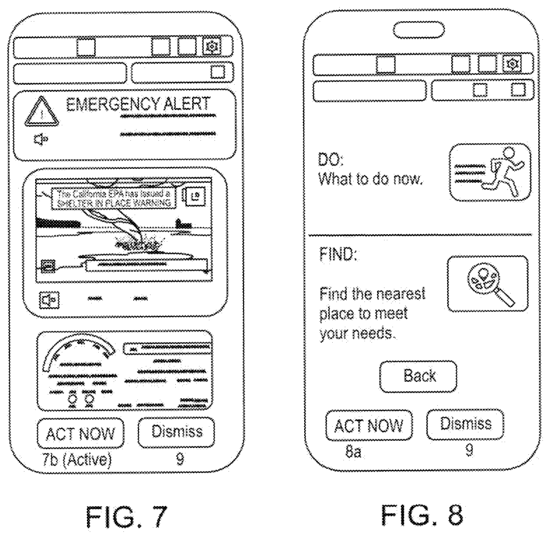

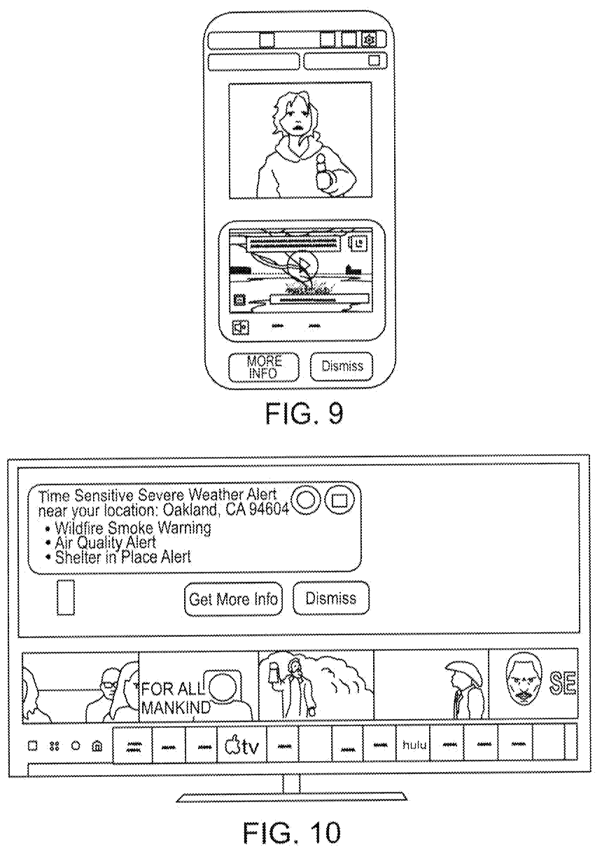

An interaction engine 20 according to the present invention, and shown in FIGS. 1 and 2 addresses time-bound engagements with individuals who require accommodations for disabilities and language barriers. The interaction engine 20 aggregates real-time information and provides nearly-immediate translation of communications, ensuring that individuals with hearing, vision, cognitive, mobility, and language challenges receive accessible content. The interaction engine is especially advantageous for emergency preparedness and response, particularly for individuals with disabilities and the aging population when shelter-in-place or evacuation orders are issued.

An important aspect of the interaction engine 20 is the ability to distill its available functions and contextual information into a comprehensive, sensory and cognitively appropriate communications session for the user. The following block diagram illustrates the functional elements of the Interaction Engine. These system elements may be implemented as a combination of interpreted language software, compiled executable applications, digital signal processing algorithms, FPGA's, ASIC's, AI algorithms and bots, and through human interaction. The elements may exist within the target device, in as part of an on-premise appliance, and as cloud-based elements. They can be distributed or centralized depending upon network architecture, fault tolerance requirements, and scaling needs.

Environmental context 22 can include, but is not limited to, climate, weather, atmosphere, political stability, traffic, hospital loading, shelter vacancies. These help to define the conditions of sheltering, transit and seeking respite and care.

Personal context 24 can include, but is not limited to, an individual's abilities and disabilities, accommodation needs for limitations in sensory, motor and cognitive functions, education and reading level, social abilities and concerns. These limitations may be developmental or acquired. They may be abnormal development or related to aging. Context may contain health information including acute or chronic conditions. Personal context may be explicit through setting up a profile (either temporary or persistent), or implicit through data gathering and intention determination methods.

Situation 26 is a current definition of current circumstances and the objectives of a journey, its mission and success state. An example situation could be a shelter in place notification in a set of zip codes due to unsafe air quality, and the mission is to inform people to stay indoors, close their windows, and operate indoor air filters if available.

Alerting and information sources 28 can typically be the catalyst for an individual to initiate action, alerting provides the commencement of notifications and gives permission to develop an action plan. Information sources provide telemetry that defines timelines and guidelines. A likely source of these notifications will be IPAWS (FEMA's Integrated Public Alert and Warning System and its associated CAP (Common Alerting protocol).

Translation 30 can involve converting one spoken language to another, text to speech, speech to text, reading level adaptation, text to sign language, sign language to text, and combinations of translation functions, for example, converting English text to Spanish sign language. These functions intend to adapt communication to the individual's preferred and best comprehended method. Translation includes translation of visual information that may be sourced from cameras or graphical representations, into actionable audible descriptions. A formative example of a translation function is the interpretation of visual weather hazard maps into audible and personally actionable information.

Supervisory Algorithm 32 leads the user experience. It is responsible for selecting tools associated with the mission goals and monitoring the individual's progress towards those goals. If needed it can call up additional assistance on behalf of an individual. It is also responsible for ensuring the interaction is appropriate for the network conditions, user device and assistive technology that may be in use.

As illustrated in FIG. 1, the interaction engine features technology providing a notification and messaging pipeline that sources information from federal agencies such as the FCC (Federal Communications Commission), FEMA (Federal Emergency Management Agency), NOAA (National Oceanic and Atmospheric Administration), the National Weather Service, state, and local alerting authorities. It processes and delivers to mobile or stationary multipurpose devices accessible versions of alerts using various methods, including sign language interpretation, text-to-speech, subtitles, audio description, plain language, and language translation. The alerts are structured to be immediately comprehensible, with sign language versions integrated directly into notifications. One aspect of the interaction engine is the delivery of emergency alerts with built-in accessibility features.

To generate accessible content, the interaction engine connects with AI-based translation services like Google Text-to-Speech and Azure AI Video Indexer. Additionally, it employs AI-driven transcription and human interpretation for elements such as audio descriptions for blind and visually impaired individuals, and sign language translations. The interaction engine can incorporate advanced AI methods for real-time accessibility enhancements.

Beyond delivering the emergency alerts themselves, the interaction engine provides personalized step-by-step instructions for preparedness and response, including evacuation. The interaction engine system continuously monitors environmental risks and provides real-time updates, escalating guidance as needed, from shelter-in-place recommendations to evacuation instructions. Users receive information on locating shelters, securing transportation, finding optimal evacuation routes, and notifying caregivers or family members of their location.

The interaction engine includes a dedicated mobile application. However, notifications and messaging can also be received via SMS or through a progressive web application (PWA) that functions across desktop and mobile browsers. An onboarding process allows users to specify their accommodation needs and grant permissions for locality-based alerts, ensuring tailored and effective communication.

Along with delivery, the interaction engine also can include a television-based delivery system. The FCC's regulations for emergency notifications via TV are similar and complementary to the emergency regulations for mobile, but some different considerations emerge for television. The interactive engine can integrate with broadcasts to comply with FCC regulations for accessible emergency information. The interaction engine system ensures that visual-only data, such as weather maps and the air quality index, often color-coded-centric is timely made audible and comprehensible to blind and visually impaired individuals through AI-driven synthesized audio descriptions.

An important feature of the interaction engine is the ability to interpret spoken, textual and visual content into multiple accessible formats, including descriptions, narration, subtext, sign language and alternate languages. This process employs real-time transcription, pre-recorded messages, and AI to deliver emergency alerts and instructions in the most comprehensible format for each user. The interaction engine employs a late-binding method for synchronizing media streams, ensuring that different accessibility features, such as sign language interpretation, audio description and text captions, are aligned accurately. This method allows content from multiple sources to be combined seamlessly at the end-user level, creating an integrated and fully accessible experience.

The interaction engine has a seamless line between human-generated communication, human-authored but machine-synthesized communication, and fully synthetic communication, providing a single, continuous mode of expression. A human may write the intent and tone, while a machine delivers it through synthesized voice, animated signing, or dynamically generated text, and in other cases the machine may generate both the content and its delivery. The blend is especially powerful in that the human part can remain constant (the message's meaning, ethics, and emotional framing), while the synthetic part becomes adaptive—tailored instantly to context, recipient, language, accessibility needs, or urgency. For example, an emergency management entity could maintain a pre-canned, human-written emergency update (“We are responding now. Stay calm and follow these steps . . . ”) and deliver it through text, a natural-sounding synthesized voice call, and an on-screen sign-language avatar, while automatically filling in form-fillable synthetic elements such as the patient's first name, the caller's location, the estimated time of arrival, nearby landmarks, and even an individualized instruction. The result feels like a single human communication—consistent, reliable, and empathetic—yet it gains the speed, personalization, and multimodal reach of synthetic systems. An underlying goal of this architecture in the context of emergency management is to manage emotional response to create a sense of clear-headed urgency.

Artifact-based communication is a feature where a reduced instruction set is transmitted using very little bandwidth, and without isochronous network requirements. The instruction set will direct the user's terminal what media rich elements to construct and convey in good fidelity. Examples of artifacts can be as simple as the identifier of a complete message pre-stored in a user's device (i.e. “[message] 3 [audio]” where bracketed items do not need to be transmitted), to as complex as a sequence of phonological parameters that render ASL signs.

Architecturally, the Interaction Engine is designed as a flexible set of distributed or centralized modules that can run on-device, at the edge, or in the cloud depending on latency, bandwidth, reliability, privacy, and regulatory constraints. It incorporates environmental context (weather, traffic, local incidents), personal context (abilities/disabilities, medical needs, reading level), and situational goals (e.g., shelter-in-place instructions) into a supervised interaction session guided by a Supervisory Algorithm. The interaction engine dynamically adapts to degraded networks—compressing or shifting communication modes, caching context locally, and maintaining two-way capability even when upstream connectivity fails. The interaction engine also introduces “artifact-based communications,” where low-bandwidth instruction codes trigger rich pre-stored media on the user's device, enabling meaningful guidance even under severe network constraints.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. An interaction engine for use with communication technology to adapt sensory media to the personal and optimal needs of an individual where real-time information is aggregated and provides nearly-immediate translation of communication ensuring that individuals having disabilities and/or language barriers receive accessible content.

2. The interaction engine as recited in claim 1 wherein said interaction engine focuses emergency preparedness and response and the individuals have disabilities and/or aging issues when shelter-in-place or evacuation orders are issued.

3. The interaction engine as recited in claim 1 wherein said interaction engine provides a notification and messaging pipeline for information from government agencies and processes and delivers accessible versions of such information utilizing communication methods directed to communications with disabilities of particular individuals.

4. The interaction engine as recited in claim 3 wherein the information is being provided in a manner to be immediately comprehensible for the receiving individuals.
